(19) United States
(12) Patent Application Publication
(10) Pub. No.: US 2013/0043987 A1
(43) Pub. Date: Feb. 21, 2013

(54) MOBILE TERMINAL APPARATUS AND CONTROL METHOD

(71) Applicants: Kouichirou KASAMA, Kawasaki (JP); Toshihiro AZAMI, Yokosuka (JP)

(72) Inventors: Kouichirou KASAMA, Kawasaki (JP); Toshihiro AZAMI, Yokosuka (JP)

(73) Assignee: FUJITSU LIMITED, Kawasaki-shi (JP)

(21) Appl. No.: 13/567,469

(22) Filed: Aug. 6, 2012

(30) Foreign Application Priority Data
Aug. 15, 2011 (JP) 2011-177496

(51) Int. Cl. G08B 6/00

(52) U.S. Cl. 340/407.1

(57) ABSTRACT

There is provided a mobile terminal apparatus that includes a vibration source unit configured to generate vibrations, each of vibrations including a frequency corresponding to an electric condition applied to the vibration source unit, a detection value collecting unit configured to collect a plurality of detection values detected by an acceleration sensor included in the mobile terminal apparatus, while the electric condition being varied, and a vibration source control unit configured to determine a specific electronic condition applied to the vibration source unit, the specific electronic condition being determined by using the plurality of detection values and the vibration source control unit configured to apply the specific electric condition to the vibration source unit when an event to be notified to a user is detected.

### CROSS-REFERENCE TO RELATED APPLICATION

This application is based upon and claims the benefit of priority of the prior Japanese Patent Application No. 2011-177496, filed on Aug. 15, 2011, the entire contents of which are incorporated herein by reference.

### FIELD

The embodiments discussed herein are related to a mobile terminal apparatus including a vibration source unit that generates vibration and a method of controlling the mobile terminal apparatus.

### BACKGROUND

It is known to vibrate a casing of a mobile device by sweeping vibrational frequency generated by a vibration generation apparatuses embedded therein, thereby the vibration of the casing is used as a notification signal.

A device is also known which generates, in response to a stimulus signal, multiple feedback signals to be perceived by a user. The electronic device includes a housing and an electronic circuit arranged in the housing. The electronic device include a unit detecting the stimulus signal; at least one resonant element capable of supplying at least two kinds of feedback signals selected from a group of an occasional feedback signal, a vibration alarm signal, an acoustic signal, and a buzzer signal; and an electrical drive circuit that drives the resonant element in response to a drive signal based on the stimulus signal.

For example, refer to Japanese Laid-open Patent Publication No. 10-258253 and Published Japanese Translation of PCT International Publication for Patent Application No. 2005-509941.

### SUMMARY

According to an aspect of the invention, a mobile terminal apparatus includes a vibration source unit configured to generate vibrations, each of vibrations including a frequency corresponding to an electric condition applied to the vibration source unit, a detection value collecting unit configured to collect a plurality of detection values detected by an acceleration sensor included in the mobile terminal apparatus, while the electric condition being varied, and a vibration source control unit configured to determine a specific electronic condition applied to the vibration source unit, the specific electronic condition being determined by using the plurality of detection values and the vibration source control unit configured to apply the specific electric condition to the vibration source unit when an event to be notified to a user is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates a first example of the hardware configuration of a mobile terminal apparatus and FIG. 1B illustrates a second example of the hardware configuration of the mobile terminal apparatus;

FIG. 2 is a block diagram schematically illustrating a first example of the configuration of the mobile terminal apparatus;

FIG. 3A is a diagram for describing a first example of a determination condition and FIG. 3B is a diagram for describing a second example of the determination condition;

FIG. 4 is a flow chart illustrating an example of a process of controlling vibrators;

FIG. 5 illustrates a third example of the hardware configuration of the mobile terminal apparatus; and

FIG. 6 is a block diagram schematically illustrating a second example of the configuration of the mobile terminal apparatus.

### DESCRIPTION OF EMBODIMENTS

In order to efficiently vibrate the mobile terminal apparatuses with the vibration source units, it is desirable to cause the mobile terminal apparatuses to resonate. However, it is not easy to predict how to set the conditions for electrical signals to be applied to the vibration source units in design in order to cause the mobile terminal apparatuses to resonate. For example, the resonant frequencies of the mobile terminal apparatus are varied depending on the difference between the individual mobile terminal apparatuses. For example, the relationship between the conditions for the electrical signals to drive the vibration source units and the vibration frequencies of the vibration source units is varied depending on the difference between the individual vibration source units. For example, the resonant frequencies of the mobile terminal apparatuses are varied depending on the statuses of the mobile terminal apparatuses, for example, depending on whether the mobile terminal apparatuses are held by hands or put into pockets of clothing or bags.

It is desirable to provide a mobile terminal apparatus and a control method, which are capable of adjusting an electric condition to be applied to a vibration source unit that vibrate the mobile terminal apparatus depending on the status thereof.

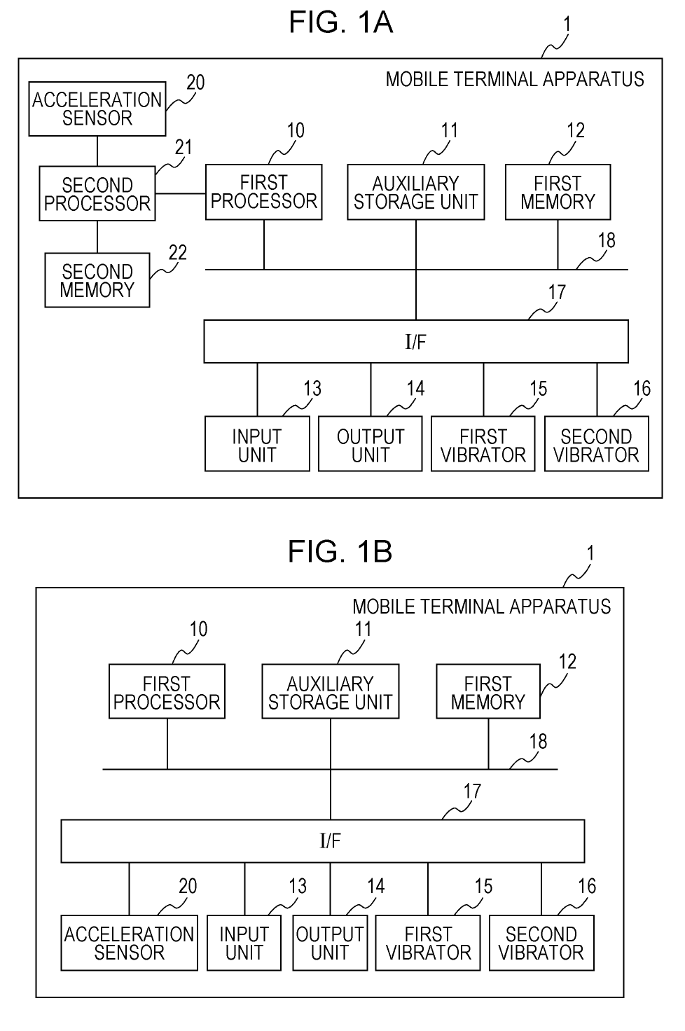

Embodiments will herein be described with reference to the attached drawings. FIG. 1A illustrates a first example of the hardware configuration of a mobile terminal apparatus and FIG. 1B illustrates a second example of the hardware configuration of the mobile terminal apparatus. A mobile terminal apparatus 1 includes a function of notifying a user of detection of a certain event by using vibration upon detection of the certain event. The mobile terminal apparatus 1 may be, for example, a mobile phone, a mobile music player, a digital camera, a portable clock, a tablet computer, or a personal digital assistant (PDA) but is not limited to the above ones.

In the first example of the hardware configuration in FIG. 1A, the mobile terminal apparatus 1 includes a first processor 10, an auxiliary storage unit 11, a first memory 12, an input unit 13, an output unit 14, a first vibrator 15, a second vibrator 16, an interface 17, an acceleration sensor 20, a second processor 21, and a second memory 22. The interface is denoted by “I/F” in the attached drawings.

The first processor 10 executes a control program stored in the auxiliary storage unit 11 to perform a variety of processing for controlling the operation of the mobile terminal apparatus 1. In addition, the first processor 10 executes an application program stored in the auxiliary storage unit 11 to perform an application process corresponding to the usage of the mobile terminal apparatus 1. The auxiliary storage unit 11 stores the control program and the application program mentioned above. The auxiliary storage unit 11 may include a non-volatile memory, a read only memory (ROM), and/or a hard disk as storage elements.

The first memory 12 stores a program that is being executed by the first processor 10 and data that is temporarily used by the program. The first memory 12 may include a random access memory (RAM). The input unit 13 is an input device that accepts an input operation by the user. The input unit 13 may be, for example, a keypad, a keyboard, a pointing device, a touch panel, or a microphone.

The output unit 14 is an output device that outputs a signal processed by the mobile terminal apparatus 1. For example, the output unit 14 may be a display device that displays information processed by the mobile terminal apparatus 1 so that the information is visible to the user. The output unit 14 may be, for example, a liquid crystal display, a cathode ray tube (CRT) display, or an organic electroluminescence display. The output unit 14 may be a speaker (loudspeaker) that outputs an audio signal or a drive circuit for the speaker.

Each of the first vibrator 15 and the second vibrator 16 is a vibration element that generates vibration of a frequency corresponding to an electric condition to be applied. The first vibrator 15 and the second vibrator 16 are examples of a vibration source unit. Each of the first vibrator 15 and the second vibrator 16 may be, for example, a linear vibration motor. The linear vibration motor generates the vibration of a frequency corresponding to a drive voltage to be applied. In this case, the electric condition defining the vibration is the magnitude of the drive voltage. In another embodiment, each of the first vibrator 15 and the second vibrator 16 may be a piezoelectric vibrator. The piezoelectric vibrator generates the vibration of a frequency corresponding to the frequency of a drive signal to be applied. In this case, the electric condition defining the vibration is the frequency of the drive signal.

These exemplified vibration elements are only examples and the first vibrator 15 and the second vibrator 16 are not limited to the above examples. The number of the vibrators is not limited to two. The mobile terminal apparatus 1 may include only one vibrator or three or more vibrators.

The embodiments in which the linear vibration motors are used as the first vibrator 15 and the second vibrator 16 are described below. In this case, the electric conditions to be applied to the first vibrator 15 and the second vibrator 16 are the magnitudes of the drive voltages.

Different drive voltages may be applied individually to the first vibrator 15 and the second vibrator 16. Accordingly, the first vibrator 15 and the second vibrator 16 are capable of vibrating at different frequencies. The vibration of the first vibrator 15 and the second vibrator 16 at different frequencies allows a surge caused by the difference in frequency to be applied to the mobile terminal apparatus 1. “Surge” depends on, for example, the difference in two frequencies and the frequency of the surge is lower than the frequencies because the frequency of the surge is usually equal to the difference. The vibration of the first vibrator 15 and the second vibrator 16 at the same frequency allows the vibration of the vibration frequencies of the respective vibrators to be applied to the mobile terminal apparatus 1.

As described above, the first vibrator 15 and the second vibrator 16 are capable of applying not only the vibration of the vibration frequencies of the respective vibrators but also the vibration of the frequency corresponding to the surge caused by the difference in frequency between the first vibrator 15 and the second vibrator 16 to the mobile terminal apparatus 1. The surge caused by the difference in frequency between the first vibrator 15 and the second vibrator 16 is lower than the vibration frequencies of the respective vibrators. Accordingly, the first vibrator 15 and the second vibrator 16 are capable of applying the vibration of frequencies lower than the respective vibration frequencies to the mobile terminal apparatus 1.

The interface 17 is an interface circuit for connecting the input unit 13, the output unit 14, the first vibrator 15, and the second vibrator 16 to a data bus 18. The first processor 10, the auxiliary storage unit 11, the first memory 12, and the interface 17 are electrically connected to each other via the data bus 18.

The acceleration sensor 20 detects the acceleration applied to the acceleration sensor 20 for each of three axis directions. The acceleration sensor 20 may be, for example, a piezoresistive three-axis acceleration sensor using a piezoresistive effect or an electrostatic capacitance type three-axis acceleration sensor using the variation in electrostatic capacitance.

The second processor 21 controls the acceleration sensor 20 and built-in hardware in the mobile terminal apparatus 1. For example, the second processor 21 performs a process of measuring the acceleration using the acceleration sensor 20. The second processor 21 may be, for example, a dedicated embedded microcomputer. The second processor 21 is electrically connected to the first processor 10 to receive various instruction signals and data from the first processor 10 and supply, to the first processor 10, data indicating the result processed in the second processor 21.

The second memory 22 stores a program to be executed by the second processor 21. The second memory 22 may be, for example, a non-volatile memory. In an embodiment, the second memory 22 may be incorporated in an embedded microcomputer with the second processor 21.

FIG. 1B illustrates the second example of the hardware configuration of the mobile terminal apparatus 1. In this example of the hardware configuration in FIG. 1B, the acceleration sensor 20 is connected to the data bus 18 via the interface 17. Accordingly, the process of measuring the acceleration using the acceleration sensor 20 is performed by the first processor 10.

The hardware configurations illustrated in FIG. 1A and FIG. 1B are only examples of the hardware configuration of the mobile terminal apparatus 1. Any other hardware configurations may be adopted as long as the processing described below is capable of being performed in the hardware configurations.

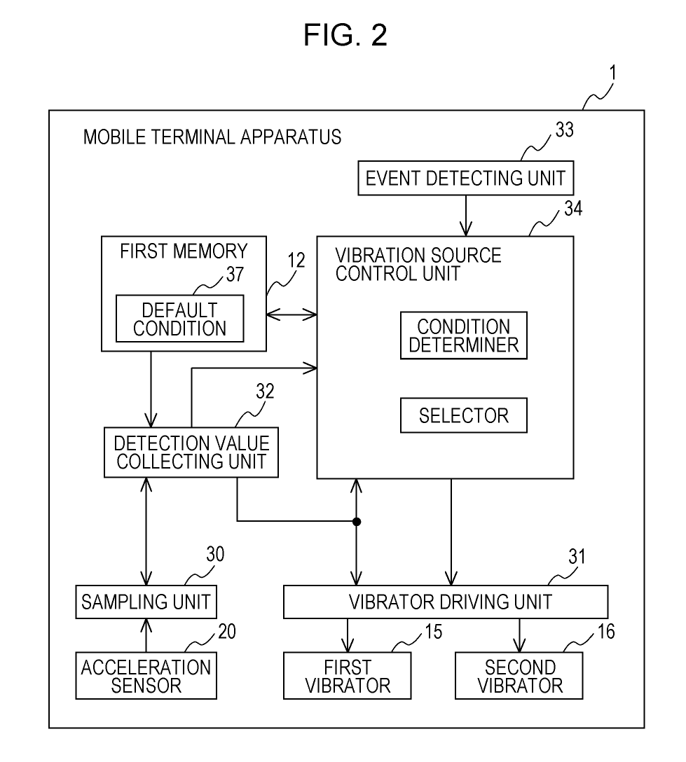

FIG. 2 is a block diagram schematically illustrating a first example of the configuration of the mobile terminal apparatus 1. Referring to FIG. 2, the mobile terminal apparatus 1 includes the first memory 12, the first vibrator 15, the second vibrator 16, the acceleration sensor 20, a sampling unit 30, and a vibrator driving unit 31. The mobile terminal apparatus 1 also includes a detection value collecting unit 32, an event detecting unit 33, and a vibration source control unit 34. FIG. 2 is illustrated with a focus on functions concerning the following description of the mobile terminal apparatus 1.

The first memory 12, the first vibrator 15, the second vibrator 16, and the acceleration sensor 20 in FIG. 2 correspond to the first memory 12, the first vibrator 15, the second vibrator 16, and the acceleration sensor 20 illustrated in FIG. 1A and FIG. 1B. The processing performed in the detection value collecting unit 32, the event detecting unit 33, and the vibration source control unit 34 is executed by the first processor 10 executing the application program stored in the auxiliary storage unit 11.

The processing performed in the vibrator driving unit 31 is executed by the first processor 10 and the interface 17. In the first example of the hardware configuration in FIG. 1A, the processing performed in the sampling unit 30 is executed by the second processor 21 executing the program stored in the second memory 22. In the second example of the hardware configuration in FIG. 1B, the processing performed in the sampling unit 30 is executed by the first processor 10 executing the program stored in the auxiliary storage unit 11.

The components illustrated in FIG. 2 will now be described. The sampling unit 30 periodically samples the accelerations in the x-axis direction, the y-axis direction, and the z-axis direction detected by the acceleration sensor 20 for every axis direction. The cycle on which the sampling unit 30 detects the detection values may be, for example, 20 milliseconds. The sampling unit 30 supplies the results of the detection of the accelerations in the respective axis directions acquired in the sampling to the detection value collecting unit 32.

The detection value collecting unit 32 acquires the detection values in the acceleration sensor 20 in a state in which the drive voltages are applied while varying the electric conditions to be applied to the first vibrator 15 and the second vibrator 16, that is, the magnitudes of the drive voltages. The detection value collecting unit 32 varies the drive voltage to be applied to each of the first vibrator 15 and the second vibrator 16 within a certain range around a certain electric condition stored in the first memory 12 in advance. The certain range may be a range of rated inputs into each vibrator. The certain electric condition is denoted by a “default condition” in the following description and reference numeral 37 is given to the default condition in the attached drawings.

In an embodiment, the default conditions defined for the first vibrator 15 and the second vibrator 16 are a voltage Vc1 and a voltage Vc2 as drive voltage, respectively. When the drive voltage to be applied to the first vibrator 15 is varied, the detection value collecting unit 32 specifies the drive voltage to be applied to the first vibrator 15 while shifting the drive voltage by a step width Δα within a range from (Vc1−α) to (Vc1+α). When the drive voltage to be applied to the second vibrator 16 is varied, the detection value collecting unit 32 specifies the drive voltage to be applied to the second vibrator 16 while shifting the drive voltage by a step width Δβ within a range from (Vc2−β) to (Vc2+β).

The detection value collecting unit 32 supplies the drive voltages to be applied to the first vibrator 15 and the second vibrator 16 to the vibrator driving unit 31. The detection value collecting unit 32 supplies the detection values in the acceleration sensor 20 acquired at the respective drive voltages to the vibration source control unit 34, along with the drive voltages in the detection.

The vibrator driving unit 31 applies the drive voltages to the first vibrator 15 and the second vibrator 16 in accordance with the specification from the detection value collecting unit 32 or the vibration source control unit 34 to drive the first vibrator 15 and the second vibrator 16.

The event detecting unit 33 detects an occurrence of a certain event that is desirably notified to the user. For example, when the mobile terminal apparatus 1 is a mobile phone, the certain event may be reception of a call or reception of an electronic mail (e-mail). For example, when the mobile terminal apparatus 1 is a portable clock or a PDA, the certain event may be arrival of an alarm time specified in advance.

The vibration source control unit 34 receives the detection values detected by the acceleration sensor 20 at the respective drive voltages from the detection value collecting unit 32, along with the drive voltages in the detection. The vibration source control unit 34 stores the detection values and the drive voltages in the first memory 12. A condition determiner 35 in the vibration source control unit 34 determines whether all the detection values stored in the first memory 12 meet a certain condition.

The certain condition determined by the vibration source control unit 34 may be, for example, a condition for determining whether the mobile terminal apparatus 1 is resonating. Various conditions may be used as the certain condition determined by the condition determiner 35 depending on the mobile terminal apparatus that is installed. For example, the following determination conditions are used in the present embodiment. Determination of the resonance of the mobile terminal apparatus 1 from the detection values in the acceleration sensor 20 may be based on these determination conditions.

(1) First Example of Determination Condition

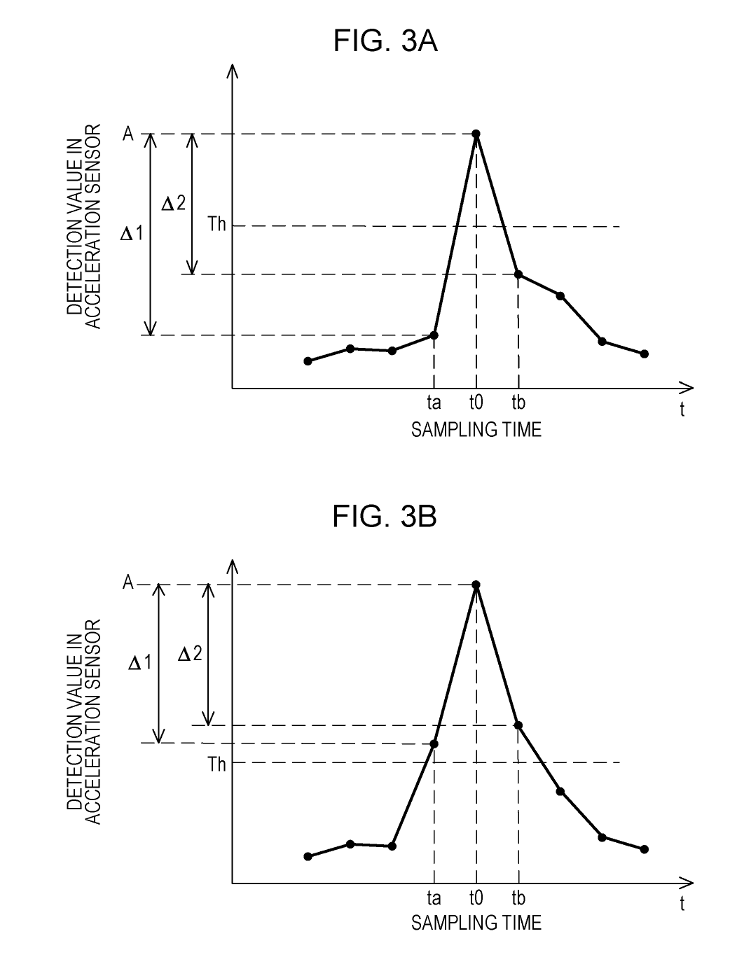

FIG. 3A is a diagram for explaining a first example of the determination condition. Referring to FIG. 3A, t0 denotes a sampling time when a target detection value is sampled, A denotes a detection value at t0, and ta and tb denote sampling times immediately before t0 and immediately after t0, respectively. The determination condition is met if the detection value is across a threshold value Th and reaches the detection value A higher than the threshold value Th during a time period from the time ta to the time t0 and a variation Δ1 in the detection value during a time period from the time ta to the time t0 and a variation Δ2 in the detection value during a time period from the time t0 to the time tb are across the threshold value Th. The determination condition is not otherwise met.

(2) Second Example of Determination Condition

FIG. 3B is a diagram for explaining a second example of the determination condition. The determination condition is met if the detection value A is higher than the threshold value Th and the variation Δ1 in the detection value during the time period from the time ta to the time t0 and the variation Δ2 in the detection value during the time period from the time t0 to the time tb exceed the threshold value Th. The determination condition is not otherwise met.

Referring back to FIG. 2, the vibration source control unit 34 determines the drive voltages at which the detection values meeting the certain condition are detected as the drive voltages to be applied to the first vibrator 15 and the second vibrator 16. When multiple drive voltages meeting the certain condition exist, the vibration source control unit 34 selects, using a selector 36, the drive voltage to be applied to each of the first vibrator 15 and the second vibrator 16 on the basis of the difference between the default condition 37 and the drive voltages. For example, the vibration source control unit 34 selects the drive voltage closest to the default condition 37 as the drive voltage to be applied to each of the first vibrator 15 and the second vibrator 16. In another embodiment, the vibration source control unit 34 arbitrarily selects a drive voltage of which the difference from the default condition 37 is within a certain allowable range and uses the selected drive voltage as the drive voltage to be applied to each of the first vibrator 15 and the second vibrator 16.

If the event detecting unit 33 detects a certain event that is desirably notified to the user, the vibration source control unit 34 supplies data related to the specification of the determined drive voltages to the vibrator driving unit 31 to cause the vibrator driving unit 31 to apply the specified drive voltages to the first vibrator 15 and the second vibrator 16.

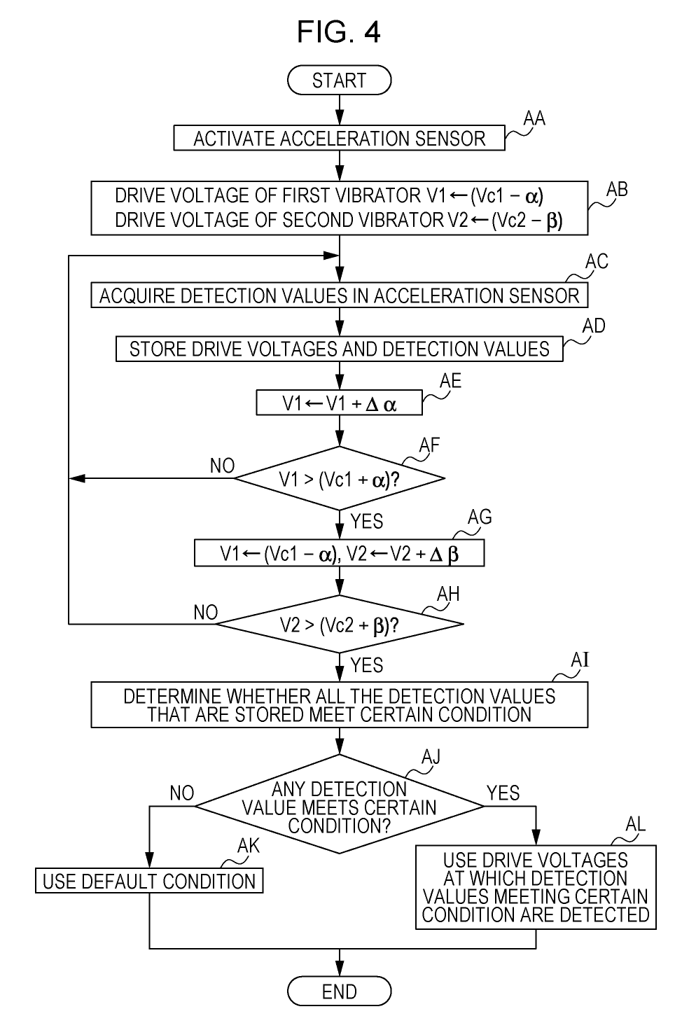

A method of controlling the first vibrator 15 and the second vibrator 16, executed by the components described above, will now be described. FIG. 4 is a flow chart illustrating an example of a process of controlling the vibrators. In other embodiments, Operations described below may be replaced with “Steps.”

Referring to FIG. 4, in Operation AA, the sampling unit 30 activates the acceleration sensor 20 to start the sampling on a certain cycle. In Operation AB, the detection value collecting unit 32 specifies lower limits (Vc1−α) and (Vc2−β) of a certain range as drive voltages V1 and V2 to be applied to the first vibrator 15 and the second vibrator 16, respectively. The drive voltages V1 and V2 are applied to the first vibrator 15 and the second vibrator 16, respectively.

In Operation AC, the detection value collecting unit 32 acquires the detection values in the acceleration sensor 20. The detection value collecting unit 32 supplies data of the detection values to the vibration source control unit 34, along with the current drive voltages. In Operation AD, the vibration source control unit 34 stores data of the detection values and the drive voltages in the first memory 12.

In Operation AE, the detection value collecting unit 32 increments the drive voltage V1 to be applied to the first vibrator 15 by the step width Δα. In Operation AF, the detection value collecting unit 32 determines whether the drive voltage V1 to be applied to the first vibrator 15 exceeds an upper limit (Vc1+α) of the certain range. If the drive voltage V1 exceeds the upper limit (Vc1+α) (YES in Operation AF), the process goes to Operation AG. If the drive voltage V1 does not exceed the upper limit (Vc1+α) (NO in Operation AF), the process goes back to Operation AC.

In Operation AG, the detection value collecting unit 32 sets the value of the drive voltage V1 to be applied to the first vibrator 15 to the lower limit (Vc1−α) of the certain range. The detection value collecting unit 32 increments the drive voltage V2 to be applied to the second vibrator 16 by the step width Δβ. In Operation AH, the detection value collecting unit 32 determines whether the drive voltage V2 to be applied to the second vibrator 16 exceeds an upper limit (Vc2+β) of the certain range. If the drive voltage V2 exceeds the upper limit (Vc2+β) (YES in Operation AH), the process goes to Operation AI. If the drive voltage V2 does not exceed the upper limit (Vc2+β) (NO in Operation AH), the process goes back to Operation AC. In Operations AB to AH described above, the detection values in the acceleration sensor 20 at the respective drive voltages when the drive voltages to be applied to the first vibrator 15 and the second vibrator 16 are varied within the certain range are collected.

In Operation AI, the vibration source control unit 34 determines whether all the detection values stored in the first memory 12 meet a certain condition. If no detection value meets the certain condition (NO in Operation AJ), the process goes to Operation AK. If any detection value meets the certain condition (YES in Operation AJ), the process goes to Operation AL.

In Operation AK, the vibration source control unit 34 uses the default condition 37 as the drive voltage to be applied to each of the first vibrator 15 and the second vibrator 16. Then, the process is terminated. In Operation AL, the vibration source control unit 34 uses the drive voltages at which the detection values meeting the certain condition are detected as the drive voltages to be applied to the first vibrator 15 and the second vibrator 16. When multiple drive voltages meeting the certain condition exist, the vibration source control unit 34 selects the drive voltage to be applied to each of the first vibrator 15 and the second vibrator 16 on the basis of the difference between the default condition 37 and the drive voltages. Then, the process is terminated.

According to the present embodiment, the vibration source control unit 34 may adjust the electric conditions to be applied to the vibrators so that the vibration generated by the first vibrator 15 and the second vibrator 16 causes the mobile terminal apparatus 1 to resonate. Accordingly, the vibration source control unit 34 may adjust the electric conditions to be applied to the first vibrator 15 and the second vibrator 16 depending on the state and the individual difference of the mobile terminal apparatus 1 and the status of the mobile terminal apparatus 1.

According to the present embodiment, it is possible to adjust the electric conditions to be applied to the vibrators so that the mobile terminal apparatus 1 is caused to resonate by the surge caused by the vibration of the first vibrator 15 and the second vibrator 16. In other words, it is possible to adjust the electric conditions to be applied to the vibrators so that the frequency of the surge caused by the vibration of the first vibrator 15 and the second vibrator 16 coincides with the resonant frequency of the mobile terminal apparatus 1. Consequently, even when the vibrators whose rated vibration frequencies are higher than the resonant frequency of the mobile terminal apparatus 1 are used, it is possible to adjust the electric conditions to be applied to the vibrators so that the mobile terminal apparatus 1 is caused to resonate.

According to the present embodiment, when multiple available electric conditions may be selected, the electric condition to be used is selected on the basis of the difference between the default condition 37 set in advance and the electric conditions. Accordingly, it is possible to specify the condition for selecting a desired electric condition from the selectable electric conditions.

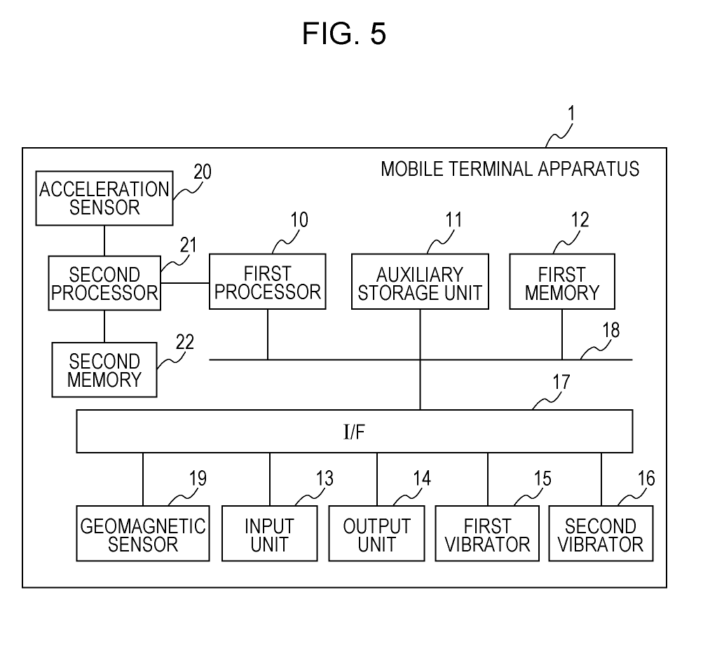

Another embodiment of the mobile terminal apparatus 1 will now be described. FIG. 5 illustrates a third example of the hardware configuration of the mobile terminal apparatus 1. The same reference numerals are used in FIG. 5 to identify the same components in the mobile terminal apparatus 1 illustrated in FIG. 1A. A description of such components is omitted herein.

Referring to FIG. 5, the mobile terminal apparatus 1 includes a geomagnetic sensor 19 that detects the bearing of the orientation of the mobile terminal apparatus 1. In another embodiment, the mobile terminal apparatus 1 may include a gyro sensor, in addition to or instead of the geomagnetic sensor 19. The interface 17 is used to connect the geomagnetic sensor 19 and/or the gyro sensor to the data bus 18. Similarly, the geomagnetic sensor 19 and/or the gyro sensor may be provided in the mobile terminal apparatus 1 illustrated in FIG. 1B.

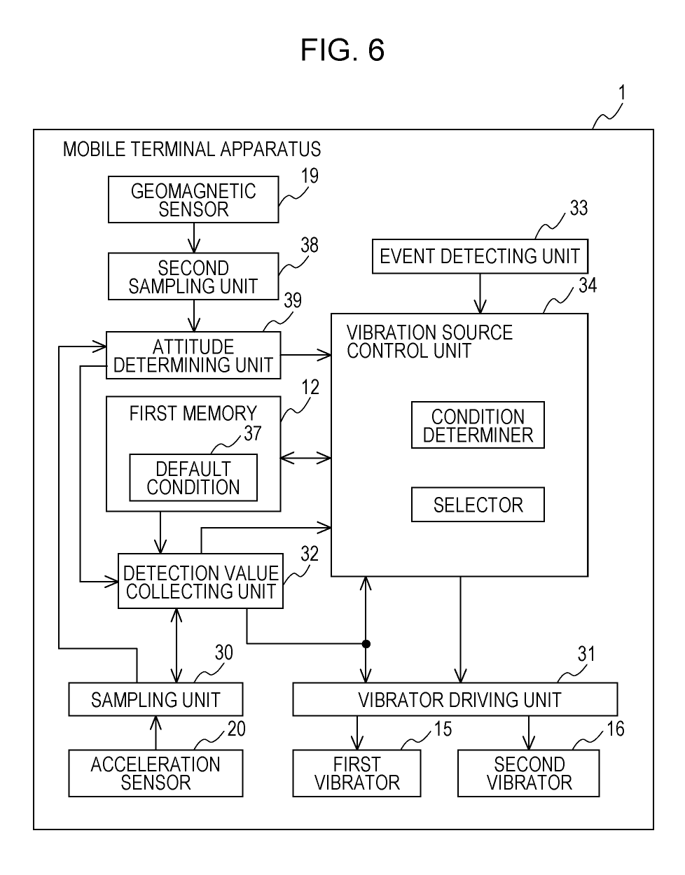

FIG. 6 is a block diagram schematically illustrating a second example of the configuration of the mobile terminal apparatus 1. The same reference numerals are used in FIG. 6 to identify the same components in the mobile terminal apparatus 1 illustrated in FIG. 2. A description of such components is omitted herein. Referring to FIG. 6, the mobile terminal apparatus 1 includes the geomagnetic sensor 19, a second sampling unit 38, and an attitude determining unit 39.

The geomagnetic sensor 19 corresponds to the geomagnetic sensor 19 illustrated in FIG. 5. The processing performed in the second sampling unit 38 and the attitude determining unit 39 is executed by the first processor 10 executing the program stored in the auxiliary storage unit 11.

The second sampling unit 38 periodically samples the bearing of the orientation of the mobile terminal apparatus 1, detected by the geomagnetic sensor 19 and sends the data of the bearing to the attitude determining unit 39. The attitude determining unit 39 determines the attitude of the mobile terminal apparatus 1 from the direction of the acceleration of gravity determined from the acceleration detected by the acceleration sensor 20 and the bearing detected by the geomagnetic sensor 19 to detect the variation in the attitude of the mobile terminal apparatus 1. In the embodiment in which the mobile terminal apparatus 1 includes the gyro sensor, the attitude determining unit 39 detects the variation in the attitude of the mobile terminal apparatus 1 from the speeds in the three-axis directions output from the gyro sensor.

The attitude determining unit 39 supplies the result of the detection of the variation in the attitude of the mobile terminal apparatus 1 to the detection value collecting unit 32 and the vibration source control unit 34. When the attitude of the mobile terminal apparatus 1 is varied, the detection value collecting unit 32 collects the detection values in the acceleration sensor 20 and the vibration source control unit 34 determines the drive voltage to be applied to the first vibrator 15 and the second vibrator 16 on the basis of the detection values.

According to the present embodiment, the vibration source control unit 34 may adjust the electric conditions to be applied to the first vibrator 15 and the second vibrator 16 each time at which the attitude of the mobile terminal apparatus 1 is varied in response to the variation of the status of the mobile terminal apparatus 1. Accordingly, the vibration source control unit 34 may adjust the electric conditions when the status of the mobile terminal apparatus 1 is varied to vary the resonant frequency of the mobile terminal apparatus 1. For example, when the resonant frequency of the mobile terminal apparatus 1 varies due to movement of the mobile apparatus 1 from on a desk into a bag, the vibration source control unit 34 may detect the variation in the attitude of the mobile terminal apparatus 1 to adjust the electric conditions.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal apparatus comprising:
a vibration source unit configured to generate vibrations, each of vibrations including a frequency corresponding to an electric condition applied to the vibration source unit;
a detection value collecting unit configured to collect a plurality of detection values detected by an acceleration sensor included in the mobile terminal apparatus, while the electric condition being varied, and
a vibration source control unit configured to determine a specific electronic condition applied to the vibration source unit, the specific electronic condition being determined by using the plurality of detection values and the vibration source control unit configured to apply the specific electric condition to the vibration source unit when an event to be notified to a user is detected.

2. The mobile terminal apparatus according to claim 1, wherein the vibration source unit includes a plurality of vibration generating elements, each of the plurality of vibration generating elements being driven by respective different electric conditions so that each of the plurality of vibration generating elements vibrates at respective different frequencies.

3. The mobile terminal apparatus according to claim 2,
wherein a vibration frequency of each of the plurality of vibration generating elements is higher than a resonant frequency of the mobile terminal apparatus.

4. The mobile terminal apparatus according to claim 1, wherein the vibration source control unit includes,
a condition determiner configured to determine whether each of the plurality of detection values meets a certain condition or not, and
a selector configured to select one of the electric conditions, the selected one being determined based on respective differences between a certain electric condition and each of electric conditions respectively different each other, when the respective detection values caused by application of each of electric conditions to the vibration source unit and each of the respective detection values meets the certain condition.

5. The mobile terminal apparatus according to claim 2, wherein the vibration source control unit includes,
a condition determiner configured to determine whether each of the plurality of detection values meets a certain condition or not, and
a selector configured to select one of the electric conditions, the selected one being determined based on respective differences between a certain electric condition and each of electric conditions respectively different each other, when the respective detection values caused by application of each of electric conditions to the vibration source unit and each of the respective detection values meets the certain condition.

6. The mobile terminal apparatus according to claim 3, wherein the vibration source control unit includes,
a condition determiner configured to determine whether each of the plurality of detection values meets a certain condition or not, and
a selector configured to select one of the electric conditions, the selected one being determined based on respective differences between a certain electric condition and each of electric conditions respectively different each other, when the respective detection values caused by application of each of electric conditions to the vibration source unit and each of the respective detection values meets the certain condition.

7. The mobile terminal apparatus according to claim 1, further comprising an attitude determiner configured to detect an attitude of the mobile terminal apparatus,
wherein the detection value collecting unit collects the plurality of detection values when the attitude of the mobile terminal apparatus is varied, and the vibration source control unit determines an electric condition to be applied to the vibration source unit on the basis of the collected plurality of detection values.

8. The mobile terminal apparatus according to claim 2, further comprising an attitude determiner configured to detect an attitude of the mobile terminal apparatus,
wherein the detection value collecting unit collects the plurality of detection values when the attitude of the mobile terminal apparatus is varied, and the vibration source control unit determines an electric condition to be applied to the vibration source unit on the basis of the collected plurality of detection values.

9. The mobile terminal apparatus according to claim 3, further comprising an attitude determiner configured to detect an attitude of the mobile terminal apparatus,
wherein the detection value collecting unit collects the plurality of detection values when the attitude of the mobile terminal apparatus is varied, and the vibration source control unit determines an electric condition to be applied to the vibration source unit on the basis of the collected plurality of detection values.

10. The mobile terminal apparatus according to claim 4, further comprising an attitude determiner configured to detect an attitude of the mobile terminal apparatus,
wherein the detection value collecting unit collects the plurality of detection values when the attitude of the mobile terminal apparatus is varied, and the vibration source control unit determines an electric condition to be applied to the vibration source unit on the basis of the collected plurality of detection values.

11. The mobile terminal apparatus according to claim 5, further comprising an attitude determiner configured to detect an attitude of the mobile terminal apparatus,
wherein the detection value collecting unit collects the plurality of detection values when the attitude of the mobile terminal apparatus is varied, and the vibration source control unit determines an electric condition to be applied to the vibration source unit on the basis of the collected plurality of detection values.

12. The mobile terminal apparatus according to claim 6, further comprising an attitude determiner configured to detect an attitude of the mobile terminal apparatus,
wherein the detection value collecting unit collects the plurality of detection values when the attitude of the mobile terminal apparatus is varied, and the vibration source control unit determines an electric condition to be applied to the vibration source unit on the basis of the collected plurality of detection values.

13. A method of controlling a vibration source unit that is provided in a mobile terminal apparatus and that generates vibration of a frequency corresponding to an electric condition to be applied to the vibration source unit, the method comprising:
collecting a detection value from an acceleration sensor provided in the mobile terminal apparatus while varying the electric condition to be applied to the vibration source unit;
determining the electric condition to be applied to the vibration source unit on the basis of the collected detection value;
detecting the presence of an event that is desirably notified to a user; and
applying the determined electric condition to the vibration source unit upon detection of the event.
